(19) United States
(12) Patent Application Publication
(10) Pub. No.: US 2026/0148920 A1
(43) Pub. Date: May 28, 2026

(54) RELAY

(71) Applicant: Xiamen Hongfa Electric Power Controls Co., Ltd., Xiamen, Fujian (CN)

(72) Inventors: Wenguang DAI, Xiamen, Fujian (CN); Liji SU, Xiamen, Fujian (CN); Meng WANG, Xiamen, Fujian (CN); Dapeng FU, Xiamen, Fujian (CN); Songsheng CHEN, Xiamen, Fujian (CN)

(21) Appl. No.: 19/120,823

(22) PCT Filed: Oct. 8, 2023
(86) PCT No.: PCT/CN2023/123428

§ 371 Date: Apr. 14, 2025

(30) Foreign Application Priority Data
Oct. 12, 2022 (CN) 202211248990.1

(51) Int. Cl. H01H 50/34; H01H 47/04; H01H 50/04; H01H 50/14; H01H 50/42; H01H 50/60

(52) U.S. Cl. CPC H01H 50/34; H01H 47/04; H01H 50/04; H01H 50/14; H01H 50/42; H01H 50/60

(57) ABSTRACT

A relay includes a contact container having a contact chamber; a pair of static lead-out terminals connected to the contact container; a first magnetizer fixedly disposed in the contact chamber; and a push rod assembly including a movable contact piece, a second magnetizer, and a third magnetizer disposed in the contact chamber; the second magnetizer and the third magnetizer are both fixedly connected to two opposite sides of the movable contact piece along the movement direction of the push rod assembly; the first magnetizer and the second magnetizer are located at a side of the movable contact piece facing the static lead-out terminals, and the second magnetizer is disposed between the first magnetizer and the movable contact piece; the second magnetizer and the third magnetizer are configured to form a first magnetic circuit, and the first magnetizer and the third magnetizer are configured to form a second magnetic circuit.

### CROSS-REFERENCE

This disclosure is the U.S. national phase application of International Application No. PCT/CN2023/123428, filed on Oct. 8, 2023, which claims priority to Chinese patent application No. 202211248990.1 filed on Oct. 12, 2022, the entire contents of which are incorporated herein by reference.

### TECHNICAL FIELD

The embodiment of present disclosure relates to the technical field of electronic components, and more specifically, to a relay.

### BACKGROUND

A relay is an electronic control device that consists of a control system (also known as the input circuit) and a controlled system (also known as the output circuit). It is commonly used in automatic control circuits. Essentially, a relay functions as an “automatic switch” that uses a smaller current to control a larger current. As such, it plays roles in automatic regulation, safety protection, and circuit switching within electrical systems.

High-voltage DC relays are a type of relay. In order to solve the problem that the contact of high voltage DC relay bounces off because of the electric repulsion generated by short circuit current, related technologies typically employ an anti-short-circuit ring electromagnetic structure. Based on the placement of the upper yoke iron, these structures are further categorized into follow-up type and fixed type. Specifically, the follow-up type structure refers that the upper yoke iron is installed on the movable component of the relay, while the fixed type structure refers that the upper yoke iron is installed in a fixed position other than the movable component. However, although the fixed-type anti-short-circuit structure has strong anti-short-circuit capability, its breaking capacity is weakened due to the negative correlation between anti-short-circuit capability and breaking capacity. On the other hand, the follow-up type anti-short-circuit structure is influenced by the holding force of the movable iron core. When the short-circuit current is high, the iron core will break off, which will lead to the disconnection of contacts, and to increase the holding force of the moving iron core, it is necessary to increase the coil, which is contrary to the small size and light weight.

### SUMMARY

In an aspect of the present disclosure, a relay including
a contact container having a contact chamber, a pair of static lead-out terminals fixedly disposed relative to the contact container, a first magnetizer disposed in the contact chamber and fixed relative to the contact container, and a push rod assembly including a movable contact piece, a second magnetizer, and a third magnetizer disposed in the contact chamber; the movable contact piece is configured to contact with or separate from the pair of static lead-out terminals; the second magnetizer and the third magnetizer are both fixedly connected to the movable contact piece, and along the movement direction of the push rod assembly, the second magnetizer and the third magnetizer are disposed at two opposite sides of the movable contact piece; the first magnetizer and the second magnetizer are located at a side of the movable contact piece facing the static lead-out terminals, and the second magnetizer is disposed between the first magnetizer and the movable contact piece; the second magnetizer and the third magnetizer are configured to form a first magnetic circuit, and the first magnetizer and the third magnetizer are configured to form a second magnetic circuit.

According to some embodiments of the present disclosure, a thickness of the first magnetizer is greater than or equal to a thickness of the second magnetizer.

According to some embodiments of the present disclosure, the contact container further has a pair of first through-holes and a second through-hole both communicating with the contact chamber; the pair of static lead-out terminals are inserted through the pair of first through-holes in one-to-one correspondence,
the relay further includes a connector inserted through the second through-hole, and including a first end and a second end, the first end is connected to the contact container, and the second end is connected to the first magnetizer.

According to some embodiments of the present disclosure, the contact container includes,
a yoke plate having a third through-hole, the push rod assembly is movably inserted through the third through-hole, and
an insulating cover including a top wall and a side wall, one end of the side wall is connected around a periphery of the top wall, and another end of the side wall is connected to the yoke plate,
wherein the first through-holes and the second through-hole are formed in the top wall, and the first end of the connector is connected to an outer surface of the top wall.

According to some embodiments of the present disclosure, the insulating cover includes a ceramic cover and a frame member, the ceramic cover includes the top wall and the side wall, the other end of the side wall is connected to the yoke plate through the frame member,
on an outer surface of the top wall, a first metallization layer is provided around a periphery of the first through-hole, and a second metallization layer is provided around the periphery of the second through-hole,
the static lead-out terminals are welded to the top wall through the first metallization layer, and the first end of the connector is welded to the top wall through the second metallization layer.

According to some embodiments of the present disclosure, the top wall and the side wall are of an integrated structure; or, the top wall and the side wall are of a separate structure.

According to some embodiments of the present disclosure, the first magnetizer is spaced apart from an inner surface of the top wall.

According to some embodiments of the present disclosure, the second end of the connector is riveted, welded, or adhesively bonded to the first magnetizer.

According to some embodiments of the present disclosure, the first magnetizer includes a plurality of stacked magnetic pieces, and the plurality of magnetic pieces are connected to the second end of the connector.

According to some embodiments of the present disclosure, the contact container includes,
a yoke plate having a third through-hole, the push rod assembly is movably inserted through the third through-hole, and
an insulating cover connected to the yoke plate,
the relay further includes a fixed frame disposed in the contact chamber and fixedly connected to the yoke plate, and the first magnetizer is fixedly connected to the fixed frame.

According to some embodiments of the present disclosure, the push rod assembly further includes,
a base, an elastic member, one end of the elastic member abuts against the base, and another end abuts against a movable member including the movable contact piece, the second magnetizer, and the third magnetizer, the elastic member provides an elastic force so that the movable contact piece has a tendency to move toward the static lead-out terminals, a limiting structure disposed on the base and the movable member, for limiting a movement range of the movable member relative to the base; the limiting structure includes a limiting hole and a limiting member that cooperate with each other, the limiting hole has a first hole wall and a second hole wall opposite to each other along the movement direction of the movable contact piece, and the limiting member is movably inserted between the first hole wall and the second hole wall of the limiting hole,
wherein, when the movable contact piece is separated from the static lead-out terminals, the limiting member is located at the first hole wall of the limiting hole.

According to some embodiments of the present disclosure, a size of the second hole wall is larger than a size of the first hole wall.

According to some embodiments of the present disclosure, the limiting member has a first curved surface used to achieve limiting with the limiting hole when the limiting member is located at the first hole wall of the limiting hole.

According to some embodiments of the present disclosure, the limiting member is a rivet, and the rivet is riveted to the third magnetizer.

According to some embodiments of the present disclosure, the movable member further includes a fixing member fixedly connected to the third magnetizer, one of the fixing member and the base is provided with the limiting member, and another of the fixing member and the base is provided with the limiting hole.

### BRIEF DESCRIPTION OF THE DRAWINGS

By referring to the accompanying drawings and describing exemplary embodiments in detail, the above and other features and advantages of the present disclosure will become more apparent.

FIG. 1 shows a perspective schematic diagram of the relay according to an embodiment of the present disclosure.

FIG. 2 shows a cross-sectional view taken along A-A plane in FIG. 1.

FIG. 3 shows a schematic diagram of the second magnetizer and the third magnetizer forming the first magnetic circuit.

FIG. 4 shows a schematic diagram of the second magnetizer and the third magnetizer forming the first magnetic circuit, as well as the first magnetizer and the third magnetizer forming the second magnetic circuit.

FIG. 5 shows an exploded schematic diagram of the static lead-out terminal, the ceramic cover, the connector, and the first magnetizer in FIG. 1.

FIG. 6 shows a cross-sectional view taken along the axis of the connector in FIG. 5.

FIG. 7 shows a schematic diagram of the push rod assembly according to the first embodiment of the present disclosure.

FIG. 8 shows an exploded schematic diagram of FIG. 7.

FIG. 9 shows a partial enlarged view of the X portion in FIG. 7.

FIG. 10 shows a cross-sectional view taken along B-B plane in FIG. 7.

FIG. 11 shows an exploded schematic diagram of the push rod assembly according to the second embodiment of the present disclosure.

FIG. 12 shows an exploded schematic diagram of the push rod assembly according to the third embodiment of the present disclosure.

FIG. 13 shows an exploded schematic diagram of the push rod assembly according to the fourth embodiment of the present disclosure.

FIG. 14 shows an exploded schematic diagram of the push rod assembly according to the fifth embodiment of the present disclosure.

FIG. 15 shows an exploded schematic diagram of the push rod assembly according to the sixth embodiment of the present disclosure.

FIG. 16 shows a schematic diagram of the first magnetizer fixedly connected to the fixed frame.

### Reference Numerals

10. contact container; 101. contact chamber; 102. first through-hole; 103. second through-hole; 11a. insulating cover; 11. ceramic cover; 111. top wall; 112. side wall; 113. first metallization layer; 114. second metallization layer; 12. frame member; 13. yoke plate; 131. third through-hole; 20. static lead-out terminal; 30. connector; 31. first end of connector; 32. second end of connector; 40. first magnetizer; 41. magnetic piece; 411. opening; 50. push rod assembly; 51. push rod; 52. base; 521. base portion; 522. first limiting member; 523. second limiting member; 524. second curved surface; 53. movable member; 54. movable contact piece; 55. third magnetizer; 551. bottom portion; 552. first side portion; 553. second side portion; 56. elastic member; 57. limiting structure; 571. limiting member; 571a. first curved surface; 572. limiting hole; 573. first hole wall of limiting hole; 574. second hole wall of limiting hole; 577. first inclined wall; 578. second inclined wall; 579. rivet; 58. fixing member; 591. second magnetizer; 592. bobbin; 593. coil; 594. static core; 595. movable core; 596. reset member; 60. drive assembly; 70. fixed frame; φ1. first magnetic circuit; φ2. second magnetic circuit; D1. movement direction; D2. length direction; D3. width direction.

### DETAILED DESCRIPTION

The exemplary embodiments will now be described more fully with reference to the accompanying drawings. However, the exemplary embodiments can be implemented in various forms and should not be construed as limited to the embodiments set forth herein. Rather, these embodiments are provided to make the present disclosure thorough and complete, and to fully convey the concepts of the exemplary embodiments to those skilled in the art. In the drawings, the same reference numerals denote the same or similar structures, and thus their detailed descriptions will be omitted.

It is to be understood that the terms “comprising” and “having” and any variations thereof in the embodiments of the present disclosure are intended to cover non-exclusive inclusion. For example, a process, method, system, product, or device that includes a series of steps or units is not limited to the listed steps or units but may optionally include steps or units not listed, or may optionally include other steps or components inherent to such processes, methods, products, or devices.

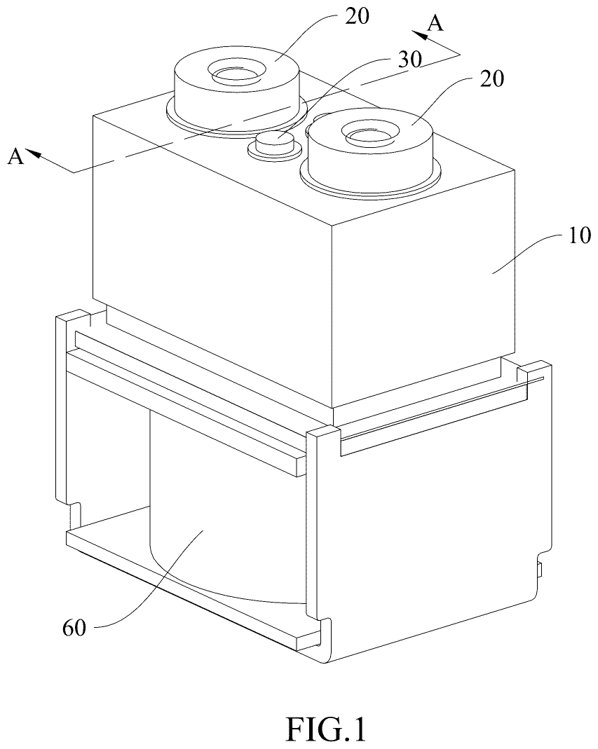

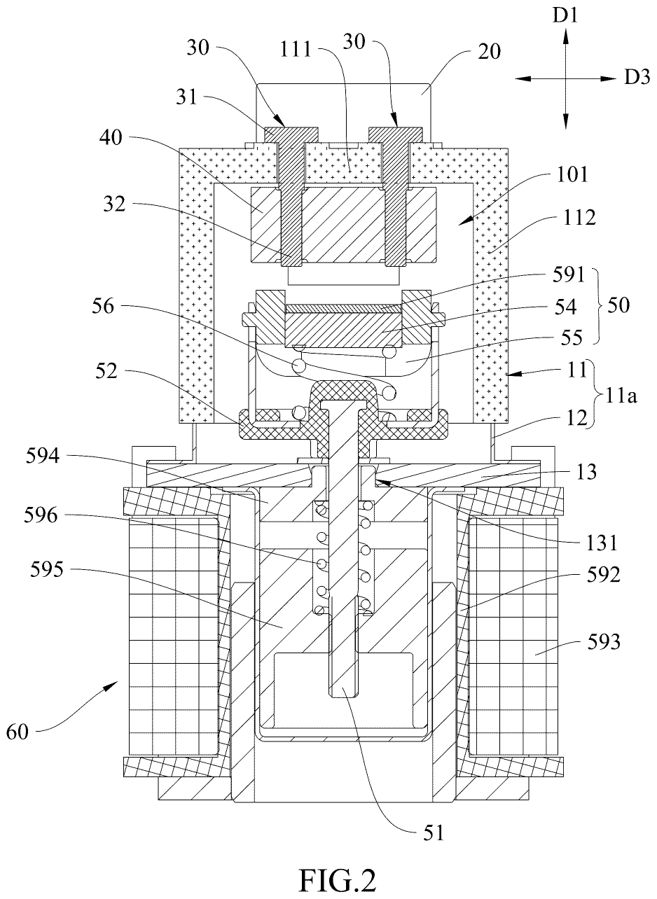

As shown in FIG. 1 and FIG. 2, FIG. 1 shows a perspective schematic diagram of the relay according to an embodiment of the present disclosure. FIG. 2 shows a cross-sectional view taken along the A-A plane in FIG. 1. The relay of the embodiment of the present disclosure includes a contact container 10, a pair of static lead-out terminals 20, a first magnetizer 40, a push rod assembly 50, and a drive assembly 60.

The contact container 10 includes a yoke plate 13 and an insulating cover 11a. The insulating cover 11a covers one side of the yoke plate 13 to form a contact chamber 101 of the contact container 10. The pair of static lead-out terminals 20 are connected to the contact container 10, with one end of each static lead-out terminal 20 extending into the contact chamber 101. The push rod assembly 50 includes a movable contact piece 54, and both ends of the movable contact piece 54 can make contact or disconnect with the pair of static lead-out terminals 20.

The drive assembly 60 is connected to the push rod assembly 50 and is used to drive the movable contact piece 54 to move, thereby achieving contact closure or separation.

As an example, the drive assembly 60 includes a bobbin 592, a coil 593, a static core 594, and a movable core 595. The bobbin 592 is hollow and cylindrical and is made of an insulating material. The coil 593 is wound around the bobbin 592. The static core 594 is fixed relative to the bobbin 592. The movable core 595 is connected to the push rod assembly 50 and is arranged opposite to the static core 594. When the coil 593 is energized, the movable core 595 is attracted by the static core 594, thereby driving the push rod assembly 50 to move and causing the movable contact piece 54 to make contact with the pair of static lead-out terminals 20.

The drive assembly 60 further includes a reset member 596, which is disposed between the static core 594 and the movable core 595 and is used to reset the movable core 595 when the coil 593 is de-energized. In one embodiment, the reset member 596 may be a spring, but is not limited thereto.

The first magnetizer 40 is disposed in the contact chamber 101 and is fixed relative to the contact container 10.

The push rod assembly 50 includes the movable contact piece 54, a second magnetizer 591, and a third magnetizer 55, all disposed in the contact chamber 101. The second magnetizer 591 and the third magnetizer 55 are both fixedly connected to the movable contact piece 54 and move together with the movable contact piece 54. Along the movement direction D1 of the push rod assembly 50, the second magnetizer 591 and at least part of the third magnetizer 55 are disposed at two opposite sides of the movable contact piece 54. The first magnetizer 40 and the second magnetizer 591 are both located at the side of the movable contact piece 54 facing the static lead-out terminals 20. Along the movement direction DI of the push rod assembly 50, the second magnetizer 591 is disposed between the first magnetizer 40 and the movable contact piece 54.

Specifically, as shown in FIG. 2, the first magnetizer 40, the second magnetizer 591, the movable contact piece 54, and the third magnetizer 55 are arranged within the contact container 10 from top to bottom. That is, the first magnetizer 40 and the second magnetizer 591 are located at one side of the movable contact piece 54, and the third magnetizer 55 is located at the opposite side of the movable contact piece 54.

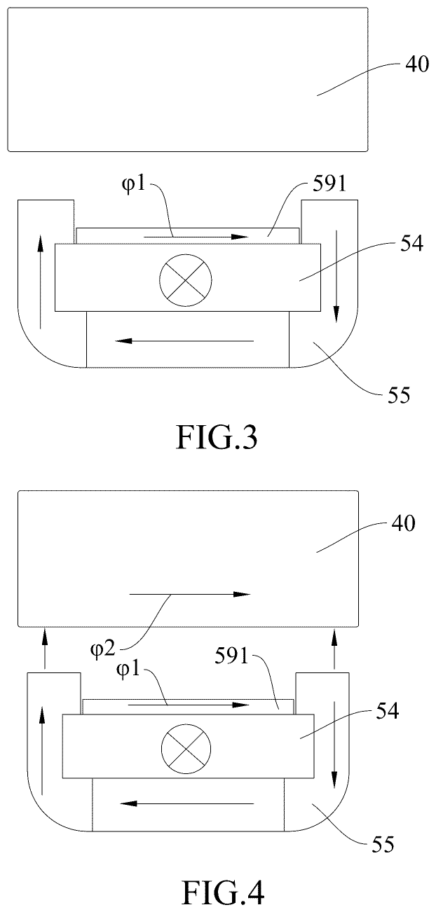

As shown in FIG. 3, FIG. 3 shows a schematic diagram of the second magnetizer 591 and the third magnetizer 55 forming a first magnetic circuit φ1. When the current passing through the movable contact piece 54 is below the limit breaking current, the magnetic flux generated in the first magnetic circuit φ1 is small. Since the second magnetizer 591 is closer to the third magnetizer 55 than the first magnetizer 40, the majority of the magnetic flux flows between the second magnetizer 591 and the third magnetizer 55 (as shown by the arrows in FIG. 3). In this case, the first magnetizer 40 hardly generates any attractive force, and since the second magnetizer 591 and the third magnetizer 55 are fixed to the movable contact piece 54, the attractive force between the second magnetizer 591 and the third magnetizer 55 is an internal force and does not exert any force on the movable contact piece 54. Therefore, when the current is below the limit breaking current, the movable contact piece 54 is not subjected to additional holding force that would affect normal breaking.

As shown in FIG. 4, FIG. 4 shows a schematic diagram of the second magnetizer 591 and the third magnetizer 55 forming the first magnetic circuit φ1, as well as the first magnetizer 40 and the third magnetizer 55 forming a second magnetic circuit φ2. When the current passing through the movable contact piece 54 gradually increases and exceeds the limit breaking current, the generated magnetic flux becomes large, causing the second magnetizer 591 to reach magnetic saturation. The remaining magnetic flux then flows to the first magnetizer 40. This forms a dual magnetic circuit, where the second magnetizer 591 and the third magnetizer 55 form the first magnetic circuit φ1, and the first magnetizer 40 and the third magnetizer 55 form the second magnetic circuit φ2. When a large short-circuit current occurs, the magnetic flux in the first magnetizer 40 generates an attractive force between the first magnetizer 40 and the third magnetizer 55. This attractive force can be used to keep the movable contact piece 54 from bouncing off under short-circuit conditions.

From the above, it can be seen that the second magnetizer 591 serves two purposes:

First, the second magnetizer 591 shares a portion of the magnetic flux, thereby reducing the attractive force between the first magnetizer 40 and the third magnetizer 55. Since both the second magnetizer 591 and the third magnetizer 55 are fixedly connected to the movable contact piece 54, the attractive force between the second magnetizer 591 and the third magnetizer 55 is an internal force. Therefore, the second magnetizer 591 reduces the attractive force between the first magnetizer 40 and the third magnetizer 55, which is beneficial for achieving limit breaking.

Second, since the first magnetizer 40 and the second magnetizer 591 are located at the same side of the movable contact piece 54, their magnetic fields are aligned in the same direction (as shown in FIG. 4, both pointing to the right). This creates a repulsive force between the first magnetizer 40 and the second magnetizer 591. Furthermore, since the first magnetizer 40 is fixed relative to the contact container 10, and the second magnetizer 591, the third magnetizer 55, and the movable contact piece 54 are fixedly connected to each other, the repulsive force exerted by the first magnetizer 40 on the second magnetizer 591 effectively acts directly on the movable contact piece 54. This repulsive force also aids in achieving limit breaking.

In view of the above, in the relay of the embodiment of the present disclosure, the second magnetizer 591 and the third magnetizer 55 can form the first magnetic circuit φ1, and the first magnetizer 40 and the third magnetizer 55 can form the second magnetic circuit φ2. Under the combined action of the first magnetizer 40, the second magnetizer 591, and the third magnetizer 55, the relay of the embodiment of the present disclosure not only enhances anti-short circuit ability but also meets the requirements for limit breaking.

It should also be noted that since the second magnetizer 591, the third magnetizer 55, and the movable contact piece 54 are fixedly connected to each other, and the first magnetizer 40 and the second magnetizer 591 are located at the same side of the movable contact piece 54, the repulsive force exerted by the first magnetizer 40 on the second magnetizer 591 effectively acts directly on the movable contact piece 54. This ensures that the movable contact piece 54 can promptly break contact with the static lead-out terminals 20, preventing contact adhesion.

It is to be understood that the first magnetizer 40, the second magnetizer 591, and the third magnetizer 55 can all be made of materials such as iron, cobalt, nickel, or their alloys.

Continue to refer to FIG. 2 to FIG. 4, the first magnetizer 40 and the second magnetizer 591 can both be straight line shape, and the third magnetizer 55 can be U-shaped, but this is not limiting.

The thickness of the first magnetizer 40 (the dimension along the movement direction D1 of the movable contact piece 54) is greater than or equal to the thickness of the second magnetizer 591. Of course, when the magnetic strength of the first magnetizer 40 is stronger, the thickness of the first magnetizer 40 can also be less than that of the second magnetizer 591.

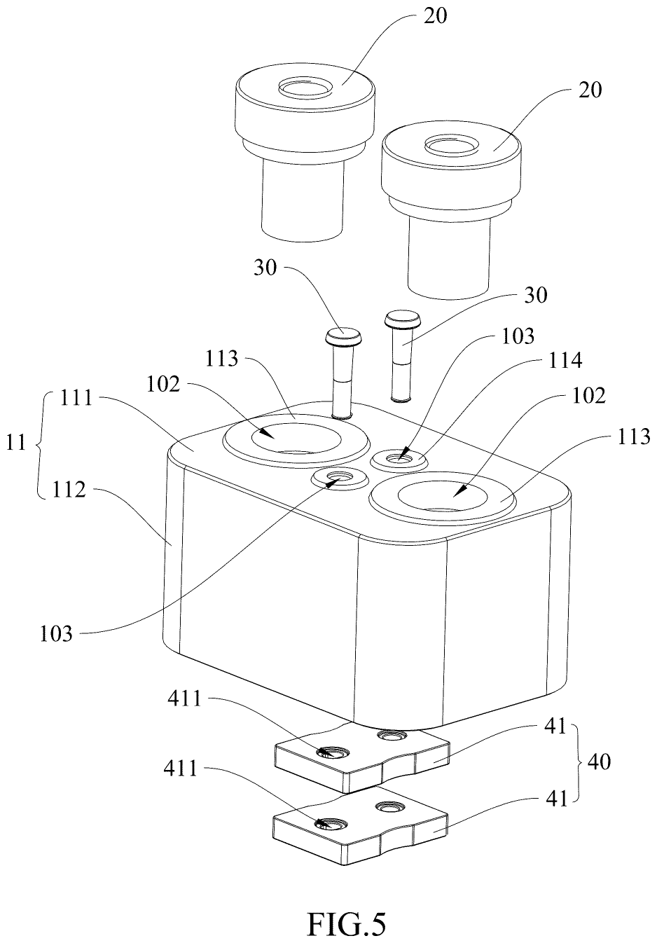

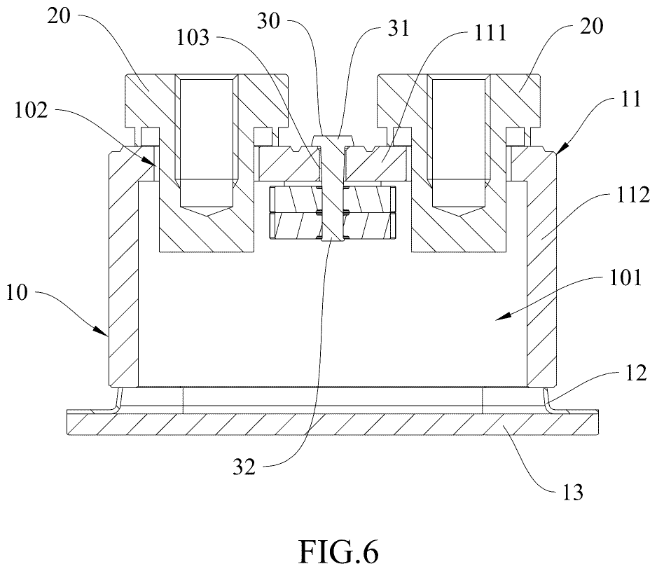

As shown in FIG. 5 and FIG. 6, FIG. 5 shows an exploded schematic diagram of the static lead-out terminals 20, the ceramic cover 11, the connector 30, and the first magnetizer 40 in FIG. 1. FIG. 6 shows a cross-sectional view taken along the axis of the connector 30 in FIG. 5. The first magnetizer 40 is fixedly connected to the contact container 10. Specifically, the contact container 10 further has a pair of first through-holes 102 and a second through-hole 103, both communicating with the contact chamber 101. The pair of static lead-out terminals 20 are respectively inserted through the pair of first through-holes 102. The relay further includes a connector 30, which is inserted through the second through-hole 103 and includes a first end 31 and a second end 32. The first end 31 is connected to the contact container 10, and the second end 32 is connected to the first magnetizer 40.

In the relay of this embodiment, the contact container 10 is provided with the second through-hole 103, and the connector 30 is inserted through the second through-hole 103, enabling the connector 30 to connect with the contact container 10 and the first magnetizer 40 to connect with the connector 30. The first magnetizer 40 is connected to the contact container 10 through the connector 30, rather than directly connecting the contact container 10, making the connection process unobstructed and visible. This not only facilitates operation but also ensures the reliability of the connection.

Referring to FIG. 2 and FIG. 6, the insulating cover 11a includes the ceramic cover 11 and a frame member 12. The ceramic cover 11 is connected to the yoke plate 13 through the frame member 12. The frame member 12 can be a ring-shaped metal component, such as an iron-nickel alloy, with one end connected to the edge of the opening of the ceramic cover 11, for example, by laser welding, brazing, resistance welding, or adhesive bonding. The other end of the frame member 12 is connected to the yoke plate 13, also by laser welding, brazing, resistance welding, or adhesive bonding. The frame member 12 between the ceramic cover 11 and the yoke plate 13 facilitates their connection.

Referring to FIG. 5, the ceramic cover 11 includes a top wall 111 and a side wall 112. One end of the side wall 112 is connected around the periphery of the top wall 111, and the other end of the side wall 112 is connected to the yoke plate 13 through the frame member 12. The first through-holes 102 and the second through-hole 103 are both formed in the top wall 111, and the first end 31 of the connector 30 is connected to the outer surface of the top wall 111.

It is to be understood that one of the pair of static lead-out terminals 20 serves as the current input terminal, and the other serves as the current output terminal. The static lead-out terminals 20 are inserted through the first through-holes 102, with part of each static lead-out terminal 20 extending into the contact chamber 101 to make contact or break contact with the movable contact piece 54. Part of each static lead-out terminal 20 is exposed on the outer surface of the ceramic cover 11.

The bottom of each static lead-out terminal 20 serves as a static contact, and two ends of the movable contact piece 54 along its length direction D2 serve as movable contacts. The movable contacts at two ends of the movable contact piece 54 may protrude from the rest of the movable contact piece 54 or be flush with it.

It is to be understood that the static contacts may be integrally or separately formed at the bottom of the static lead-out terminals 20, and the movable contacts may be integrally or separately formed at two ends of the movable contact piece 54 along its length direction D2.

The second through-hole 103 may be located between the two first through-holes 102, meaning the connector 30 is located between the pair of static lead-out terminals 20.

The number of connectors 30 may be one or more. In this embodiment, there are two connectors 30, but this is not limiting.

Please continue to refer to FIG. 5. On the outer surface of the top wall 111 of the ceramic cover 11, a first metallization layer 113 is provided around the periphery of the first through-hole 102, and a second metallization layer 114 is provided around the periphery of the second through-hole 103. The static lead-out terminals 20 are welded to the top wall 111 through the first metallization layer 113, and the first end 31 of the connector 30 is welded to the top wall 111 through the second metallization layer 114.

Compared to the inner surface of the ceramic cover 11, the outer surface of the top wall 111 is easier to form a welding plane. Additionally, since the top wall 111 of the ceramic cover 11 needs to accommodate the static lead-out terminals 20, and the static lead-out terminals 20 are welded to the top wall 111, a metallization layer is also required around the periphery of the first through-hole 102. Therefore, when processing the first metallization layer 113 for the first through-hole 102, the second metallization layer 114 for the second through-hole 103 is also processed. Thus, by welding the connector 30 to the outer surface of the top wall 111 of the ceramic cover 11, metallization layers need only be processed on the outer surface of the top wall 111, simplifying the processing steps.

The first magnetizer 40 is spaced apart from the inner surface of the top wall 111, allowing the length of the connector 30 to be greater than the sum of the thickness of the top wall 111 and the thickness of the first magnetizer 40. This enables the first magnetizer 40 to be suspended from the top wall 111 of the ceramic cover 11 through the connector 30.

By spacing the first magnetizer 40 from the inner surface of the top wall 111, a gap is created between the first magnetizer 40 and the inner surface of the top wall 111. Since the first magnetizer 40 does not directly contact the inner surface of the top wall 111, its presence does not affect the creepage distance of the pair of static lead-out terminals 20.

Please continue to refer to FIG. 5 and FIG. 6. The first magnetizer 40 includes a plurality of stacked magnetic pieces 41, and the plurality of magnetic pieces 41 are connected to the second end 32 of the connector 30. Each magnetic piece 41 is provided with an opening 411, through which the connector 30 passes and is riveted to the magnetic piece 41.

Of course, when the first magnetizer 40 includes a plurality of stacked magnetic pieces 41, the opening 411 in the lowermost magnetic piece 41 may be a blind hole, while the openings 411 in the remaining magnetic pieces 41 are through-holes. The connector 30 passes through the openings 411 in the remaining magnetic pieces 41, and the second end of the connector 30 extends into the blind hole of the lowermost magnetic piece 41 and is welded to it.

Additionally, when the first magnetizer 40 is a single piece, it is provided with an opening 411, which may be a through-hole or a blind hole. When the opening 411 is a through-hole, the connector 30 passes through the opening 411 and is riveted to the first magnetizer 40. When the opening 411 is a blind hole, solder may be placed inside the blind hole, and the second end 32 of the connector 30 extends into the blind hole and is welded to the first magnetizer 40.

As an example, when the short-circuit current exceeds 10 kA, the thickness of the first magnetizer 40 needs to be increased to generate a greater magnetic attractive force, ensuring that the magnetic attractive force between the first magnetizer 40 and the second magnetizer 591 can overcome the repulsive force generated by the short-circuit current and prevent the movable contact piece 54 from bouncing off the static lead-out terminals 20. However, a thicker first magnetizer 40 is costly and more difficult to connect to the ceramic cover 11.

In this embodiment, since the first magnetizer 40 is connected to the contact container 10 through the connector 30, the first magnetizer 40 can include a plurality of stacked magnetic pieces 41, and the connector 30 passes through the second through-hole 103 in the plurality of magnetic pieces 41 for connection. By increasing the number of thinner magnetic pieces 41, the overall thickness of the first magnetizer 40 is increased. On one hand, the magnetic pieces 41 are thin and can be made from thin strip material, reducing material costs and facilitating operation. On the other hand, the number of magnetic pieces 41 can be flexibly adjusted according to the magnitude of the short-circuit current.

It is to be understood that the second magnetizer 591 and the third magnetizer 55 may also each include a plurality of stacked magnetic pieces, or the third magnetizer 55 may include multiple U-shaped magnetic bodies arranged side by side.

The top wall 111 and the side wall 112 of the ceramic cover 11 may be separate structures, connected by welding. It is to be understood that designing the ceramic cover 11 with separate top wall 111 and side wall 112 structures makes it easier to connect the connector 30 to the top wall 111. Of course, the top wall 111 and the side wall 112 may also be connected by adhesive bonding.

Since the top wall 111 is plate-shaped, the plate structure makes it easier to process the first through-hole 102, the second through-hole 103, the first metallization layer 113, and the second metallization layer 114 on the top wall 111. Furthermore, the plate structure also facilitates the welding of the connector 30 to the top wall 111 and the static lead-out terminals 20 to the top wall 111.

Of course, the top wall 111 and the side wall 112 of the ceramic cover 11 may also be an integrated structure.

The connection between the second end 32 of the connector 30 and the first magnetizer 40 can be implemented in various ways, such as welding, riveting, or adhesive bonding.

In this embodiment, the second end 32 of the connector 30 is riveted to the first magnetizer 40. Specifically, the second end 32 of the connector 30 and the first magnetizer 40 are connected by flaring riveting.

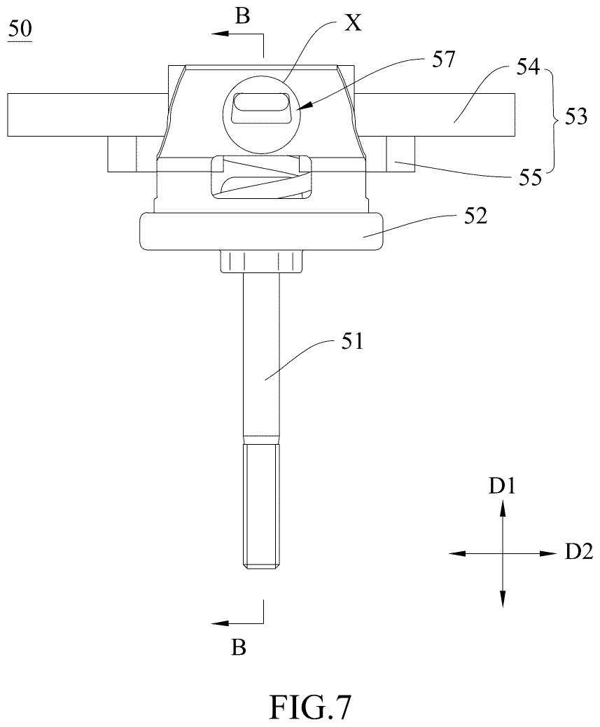

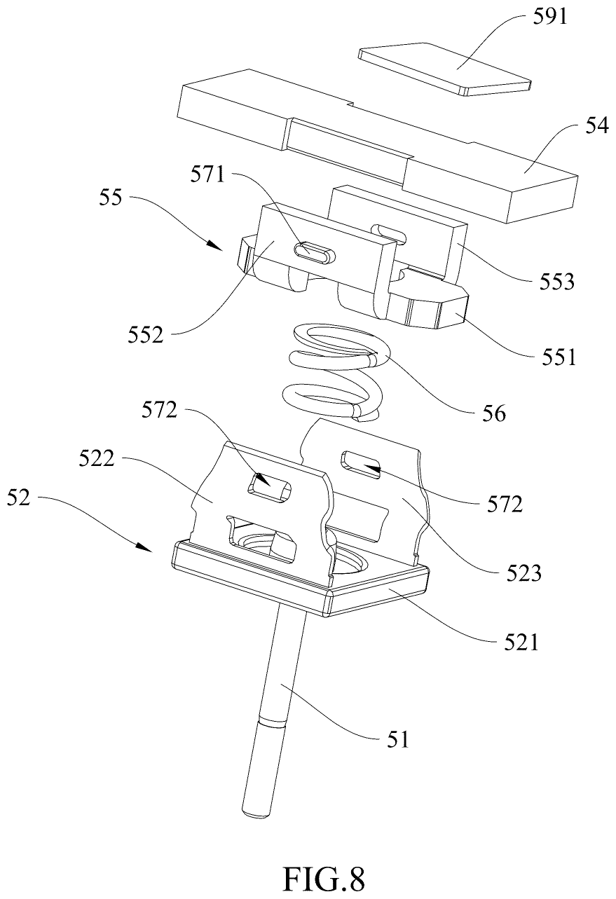

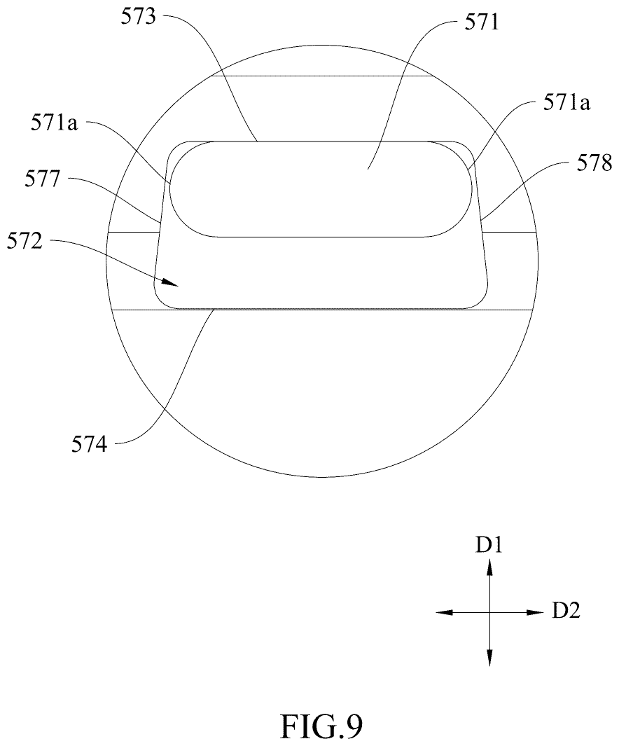

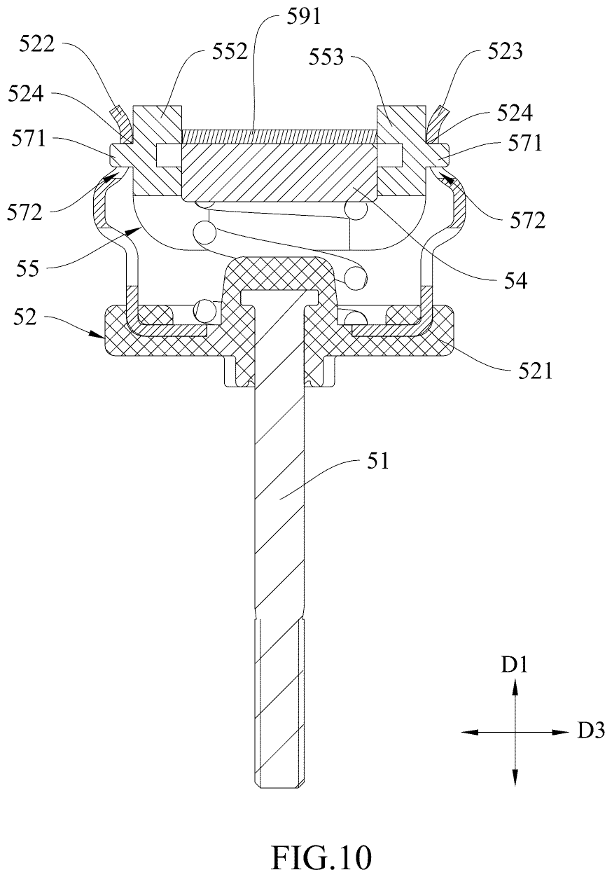

As shown in FIG. 7 to FIG. 10, FIG. 7 shows a schematic diagram of the push rod assembly 50 according to the first embodiment of the present disclosure. FIG. 8 shows an exploded schematic diagram of FIG. 7. FIG. 9 shows a partial enlarged view of the X portion in FIG. 7. FIG. 10 shows a cross-sectional view taken along the B-B plane in FIG. 7.

The push rod assembly 50 further includes a push rod 51, a base 52, an elastic member 56, and a limiting structure 57. The push rod 51 is movably inserted through the third through-hole 131 in the yoke plate 13 (see FIG. 2). One end of the push rod 51 is connected to the base 52, and the other end is connected to the movable core 595 of the relay (see FIG. 2). One end of the elastic member 56 abuts against the base 52, and the other end abuts against the movable member 53 composed of the movable contact piece 54, the second magnetizer 591, and the third magnetizer 55. The elastic member 56 provides an elastic force to bias the movable contact piece 54 toward the static lead-out terminals 20.

It is to be understood that the elastic member 56 may be a spring, but this is not limiting.

The limiting structure 57 is connected to the base 52 and the movable member 53 and is used to limit the movement range of the movable member 53 relative to the base 52. The limiting structure 57 includes a limiting hole 572 and a limiting member 571 that cooperate with each other. The limiting hole 572 includes a first hole wall 573 and a second hole wall 574 opposite to each other along the movement direction D1 of the movable contact piece 54. The size of the second hole wall 574 (the length along the length direction D2 of the movable contact piece 54) is larger than that of the first hole wall 573. The limiting member 571 is movably inserted between the first hole wall 573 and the second hole wall 574 of the limiting hole 572. When the movable contact piece 54 is separated from the static lead-out terminals 20, the limiting member 571 is located at the first hole wall 573 of the limiting hole 572.

In this embodiment, the base 52 is directly connected to the movable member 53 through the limiting structure 57, simplifying the assembly between the base 52 and the movable member 53. Moreover, since there are no other components above the movable member 53, interference between these components and the first magnetizer 40 during overtravel is avoided.

It is to be understood that the limiting hole 572 may be a through-hole or a blind hole.

When the movable contact piece 54 is not in contact with the static lead-out terminals 20, the limiting member 571 abuts against the first hole wall 573 of the limiting hole 572 under the action of the elastic member 56. When the movable contact piece 54 is in contact with the static lead-out terminals 20 and completes the overtravel process, the limiting member 571 moves from the first hole wall 573 to the second hole wall 574 of the limiting hole 572. Since the size of the second hole wall 574 is larger than that of the first hole wall 573, the limiting hole 572 has a structure that one end is big and the other end is small. During overtravel, the gap between the limiting member 571 and the hole wall of the limiting hole 572 increases, preventing friction and jamming between the limiting member 571 and the hole wall during the movement of the movable contact piece 54 relative to the base 52. At the same time, the smaller size of the first hole wall 573 does not affect the limiting cooperation between the limiting member 571 and the limiting hole 572 in the initial state, preventing the movable contact piece 54 from wobbling relative to the base 52.

It should be noted that to achieve the limiting of the movable contact piece 54 relative to the base 52 in the initial state, the size of the first hole wall 573 of the limiting hole 572 should match the shape of the limiting member 571, ensuring that when the limiting member 571 is located at the first hole wall 573, it can effectively limit the movement of the movable contact piece 54.

Please continue to refer to FIG. 7 to FIG. 10. From the first hole wall 573 to the second hole wall 574 of the limiting hole 572, the size of the limiting hole 572 gradually increases. During the overtravel process, as the limiting member 571 moves from the first hole wall 573 to the second hole wall 574 of the limiting hole 572, the gap between the limiting member 571 and the hole walls of the limiting hole 572 gradually increases.

Specifically, the limiting hole 572 has a first hole wall 573 and a second hole wall 574 arranged horizontally and opposite to each other, as well as a first inclined wall 577 and a second inclined wall 578 opposite to each other. One end of the first inclined wall 577 and the second inclined wall 578 are respectively connected to two ends of the first hole wall 573, and the other ends are respectively connected to two ends of the second hole wall 574.

In this embodiment, the shape of the limiting hole 572 is approximately an isosceles trapezoid, but this is not limiting. For example, the shape of the limiting hole 572 may also be a general trapezoid, where the slopes of the first inclined wall 577 and the second inclined wall 578 are not equal. In other embodiments, the shape of the limiting hole 572 may also be a triangle, preferably an isosceles triangle.

Of course, in other implementations, the size of the limiting hole 572 may not gradually increase from the first hole wall 573 to the second hole wall 574. For example, the hole wall of the limiting hole 572 may also include sections of equal diameter and expanded diameter. For instance, from the first hole wall 573 to the second hole wall 574, the hole wall of the limiting hole 572 may sequentially include an expanded section, an equal-diameter section, an expanded section, and an equal-diameter section.

As shown in FIG. 9, the limiting member 571 has a first curved surface 571a, which is used to achieve limiting with the first inclined wall 577 and the second inclined wall 578 of the limiting hole 572 when the limiting member 571 is located at the first hole wall 573 of the limiting hole 572.

In this embodiment, by designing the outer side wall of the limiting member 571 to include the first curved surface 571a, the first curved surface 571a and the first inclined wall 577 and the second inclined wall 578 of the limiting hole 572 are in line contact. This line contact reduces the friction between the limiting member 571 and the hole wall of the limiting hole 572. When the limiting member 571 and the limiting hole 572 move relative to each other, jamming is less likely to occur.

The base 52 is provided with the limiting hole 572, and the movable member 53 includes the limiting member 571. Of course, in other implementations, the limiting hole 572 may also be provided on the movable member 53, and the limiting member 571 may be provided on the base 52.

As shown in FIG. 7 to FIG. 10, in this embodiment, the base 52 is provided with the limiting hole 572, and the third magnetizer 55 is provided with the limiting member 571. The third magnetizer 55 includes a bottom portion 551, a first side portion 552, and a second side portion 553. The first side portion 552 and the second side portion 553 are respectively connected to two ends of the bottom portion 551 along the width direction D3 of the movable contact piece 54. The first side portion 552 and the second side portion 553 are respectively arranged on two opposite sides of the movable contact piece 54 along its width direction D3. Both the first side portion 552 and the second side portion 553 are provided with the limiting member 571.

It is to be understood that the movement direction D1, the length direction D2, and the width direction D3 are mutually perpendicular.

The base 52 includes a base portion 521, and a first limiting member 522 and a second limiting member 523 both connected to the base portion 521 and arranged opposite to each other. The first side portion 552 corresponds to the first limiting member 522, and the second side portion 553 corresponds to the second limiting member 523. Both the first limiting member 522 and the second limiting member 523 are provided with the limiting hole 572.

The side surface of the first limiting member 522 facing the first side portion 552 and the side surface of the second limiting member 523 facing the second side portion 553 each includes a second curved surface 524.

In this embodiment, by designing the side surfaces of the first limiting member 522 facing the first side portion 552 and the second limiting member 523 facing the second side portion 553 to each includes the second curved surface 524, the two second curved surfaces 524 are in line contact with the first side portion 552 and the second side portion 553, respectively. This line contact reduces the friction between the first side portion 552 and the first limiting member 522, as well as between the second side portion 553 and the second limiting member 523. When the third magnetizer 55 moves relative to the base 52, jamming is less likely to occur. Moreover, it prevents the generation of scrapings that could contaminate the contact chamber 101 of the relay.

The first side portion 552 and the second side portion 553 are located between the first limiting member 522 and the second limiting member 523. The side of the first side portion 552 facing away from the second side portion 553 and the side of the second side portion 553 facing away from the first side portion 552 are both provided with the limiting member 571.

As an example, the limiting member 571 may be formed by stamping the side surfaces of the first side portion 552/second side portion 553, creating a stamped protrusion structure. The specific position of the stamped protrusion structure on the first side portion 552/second side portion 553 can be flexibly adjusted according to the structure.

In this embodiment, since the two limiting members 571 are respectively provided on the side of the first side portion 552 facing away from the second side portion 553 and the side of the second side portion 553 facing away from the first side portion 552, the first side portion 552 and the second side portion 553 can fully contact the first limiting member 522 and the second limiting member 523, respectively. This ensures the stability of the third magnetizer 55 relative to the base 52 during limiting and does not affect magnetic conduction efficiency.

In one implementation, the limiting member 571 may be elongated. When the limiting member 571 is located at the first hole wall 573 of the limiting hole 572, the larger side surface of the elongated limiting member 571 contacts the first hole wall 573 of the limiting hole 572. By having the larger surface of the limiting member 571 contact the hole wall of the limiting hole 572, the swinging of the movable contact piece 54 relative to the base 52 in the initial state is effectively prevented, reducing the probability of the movable contact piece 54 bouncing or rebounding.

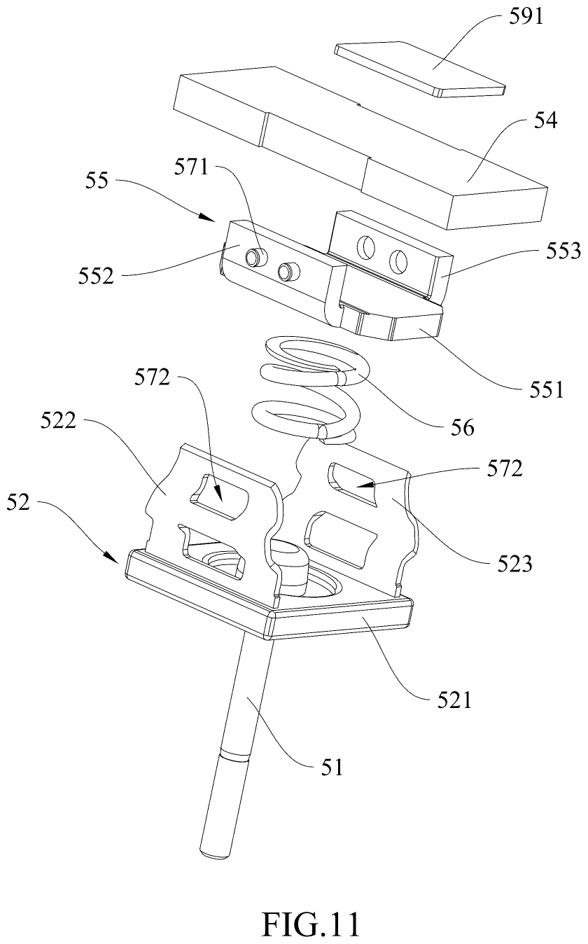

As shown in FIG. 11, FIG. 11 shows an exploded schematic diagram of the push rod assembly 50 according to the second embodiment of the present disclosure. The second embodiment is similar to the first embodiment described above, and the same parts will not be repeated. The differences are as follows.

The limiting member 571 includes two protrusion structures. The two protrusion structures are spaced apart along the length direction D2 of the movable contact piece 54. The design of the dual-protrusion structure effectively prevents the movable contact piece 54 from swinging relative to the base 52 in the initial state, reducing the probability of the movable contact piece 54 bouncing or rebounding.

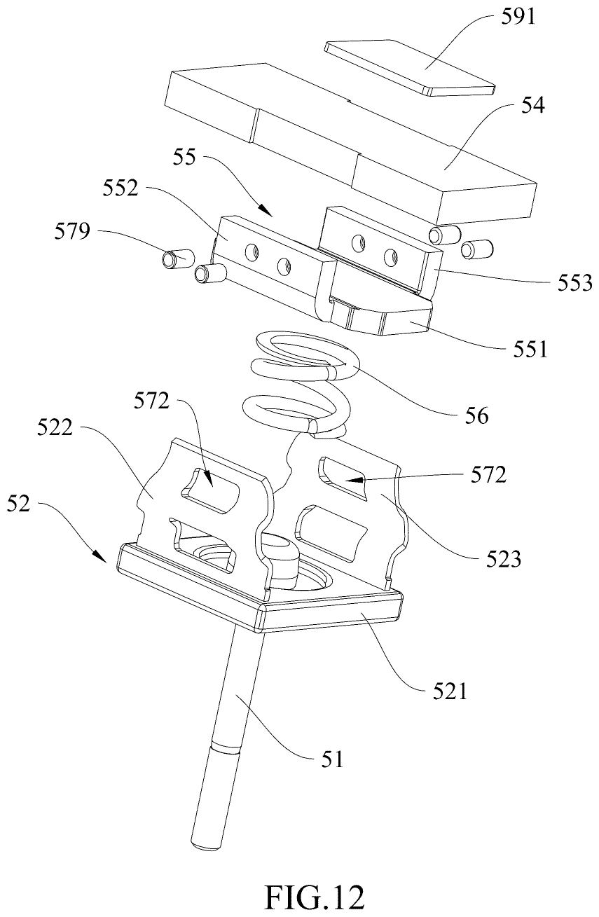

As shown in FIG. 12, FIG. 12 shows an exploded schematic diagram of the push rod assembly 50 according to the third embodiment of the present disclosure. The third embodiment is similar to the first embodiment described above, and the same parts will not be repeated. The differences are as follows.

The limiting member 571 is a rivet 579, and the rivet 579 is riveted to the first side portion 552/second side portion 553 of the third magnetizer 55.

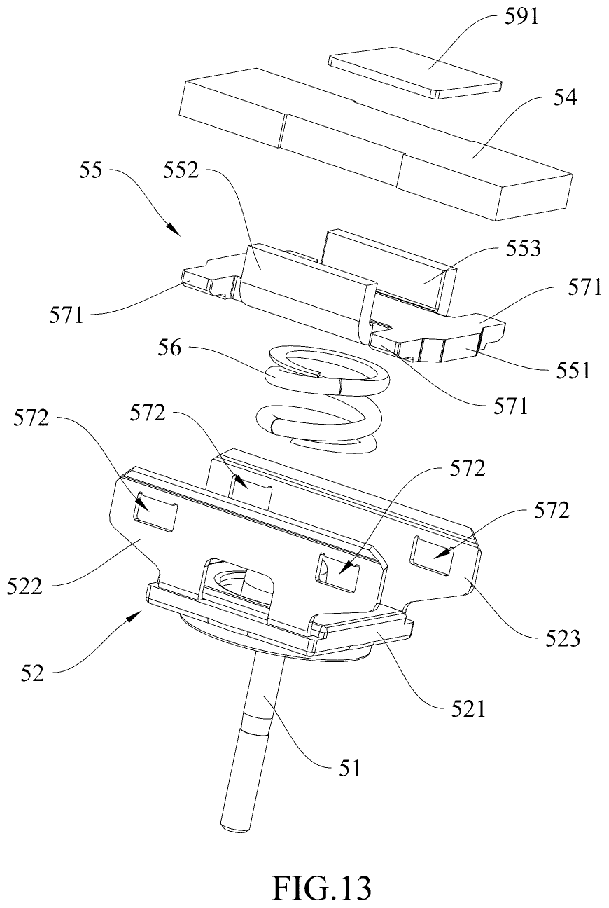

As shown in FIG. 13, FIG. 13 shows an exploded schematic diagram of the push rod assembly 50 according to the fourth embodiment of the present disclosure. The fourth embodiment is similar to the first embodiment described above, and the same parts will not be repeated. The differences are as follows. The limiting member 571 is provided on the bottom portion 551 of the third magnetizer 55.

Specifically, the third magnetizer 55 includes a bottom portion 551, a first side portion 552, and a second side portion 553. Along the width direction D3 of the movable contact piece 54, the two opposite sides of the bottom portion 551 are both provided with the limiting member 571. The first side portion 552 and the second side portion 553 are respectively connected to two ends of the bottom portion 551 along the width direction D3 of the movable contact piece 54. The first side portion 552 and the second side portion 553 are respectively arranged on two opposite sides of the movable contact piece 54 along its width direction D3.

The base 52 includes a base portion 521, and a first limiting member 522 and a second limiting member 523 connected to the base portion 521 and arranged opposite to each other. Both the first limiting member 522 and the second limiting member 523 are provided with the limiting hole 572.

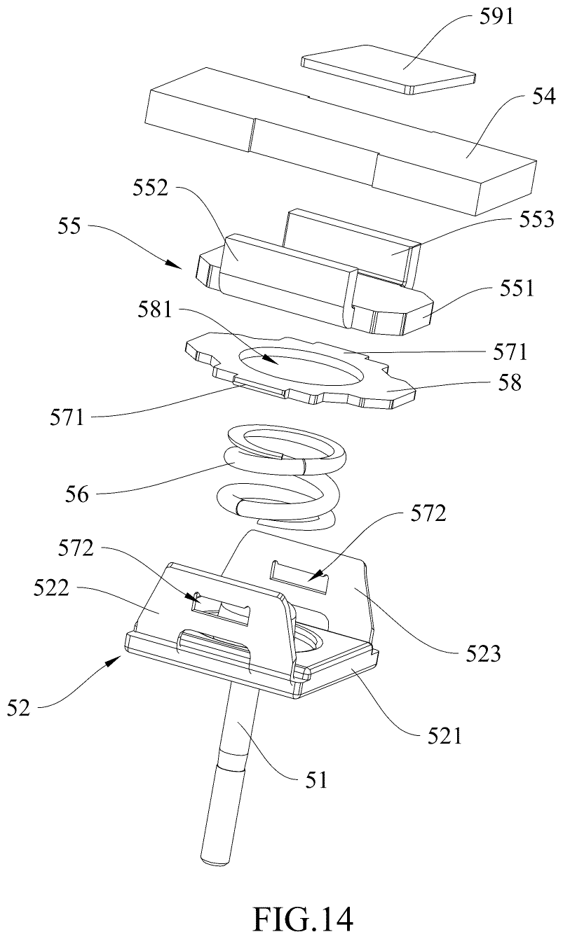

As shown in FIG. 14, FIG. 14 shows an exploded schematic diagram of the push rod assembly 50 according to the fifth embodiment of the present disclosure. The fifth embodiment is similar to the first embodiment described above, and the same parts will not be repeated. The differences are as follows.

The base 52 includes a base portion 521, and a first limiting member 522 and a second limiting member 523 connected to the base portion 521 and arranged opposite to each other. Both the first limiting member 522 and the second limiting member 523 are provided with the limiting hole 572. The movable member 53 further includes a fixing member 58 fixedly connected to the third magnetizer 55. Both sides of the fixing member 58 are provided with the limiting member 571.

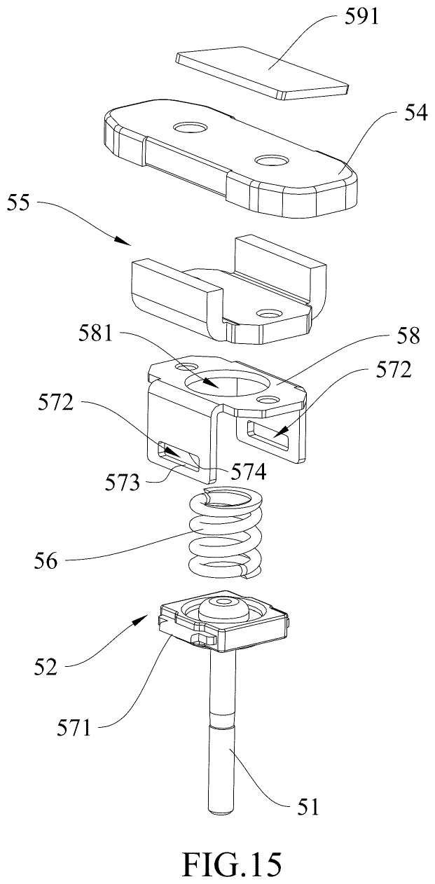

As shown in FIG. 15, FIG. 15 shows an exploded schematic diagram of the push rod assembly 50 according to the sixth embodiment of the present disclosure. The sixth embodiment is similar to the first embodiment described above, and the same parts will not be repeated. The differences are as follows.

The limiting member 571 is provided on two opposite sides of the base 52 of the push rod assembly 50. The movable member 53 further includes a fixing member 58 fixedly connected to the third magnetizer 55. The fixing member 58 is provided with the limiting hole 572.

The fixing member 58 is inverted U-shaped, and the positions of the first hole wall 573 and the second hole wall 574 of the limiting hole 572 on the fixing member 58 are opposite to those in the above embodiments.

Specifically, as shown in FIG. 15, the first hole wall 573 of the limiting hole 572 is located at the bottom, while the second hole wall 574 is located at the top, and the size of the second hole wall 574 is larger than that of the first hole wall 573.

As shown in FIG. 11 to FIG. 14, the first hole wall 573 of the limiting hole 572 is located at the top, while the second hole wall 574 is located at the bottom.

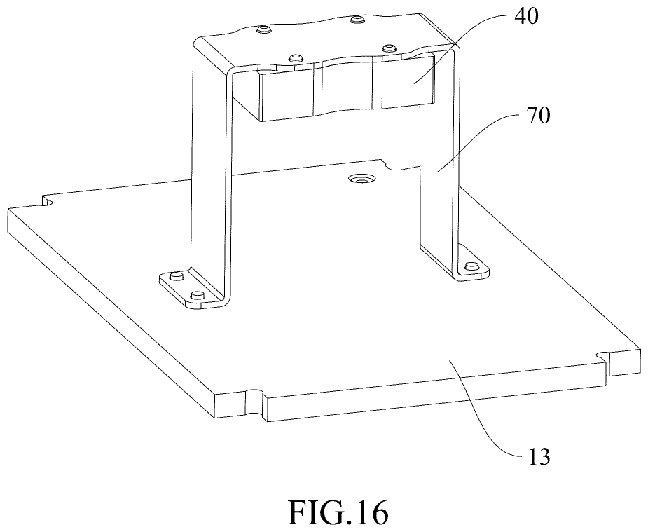

As shown in FIG. 16, FIG. 16 shows a schematic diagram of the first magnetizer 40 fixedly connected to a fixed frame 70. Except that the first magnetizer 40 is fixedly connected to the ceramic cover 11 as described above, the first magnetizer 40 may also be fixedly connected to a fixed frame 70.

Specifically, the relay further includes a fixed frame 70, which is disposed in the contact chamber 101 and fixedly connected to the yoke plate 13. The first magnetizer 40 is fixedly connected to the fixed frame 70. The relative positional relationships between the first magnetizer 40, the second magnetizer 591, the third magnetizer 55, and the movable contact piece 54 can be referred to the above description and will not be repeated here.

One embodiment of the present disclosure has at least the following advantages or beneficial effects:

In the relay of the embodiment of the present disclosure, the second magnetizer and the third magnetizer can form a first magnetic circuit, and the first magnetizer and the third magnetizer can form a second magnetic circuit. Under the combined action of the first magnetizer, the second magnetizer, and the third magnetizer, the relay of the embodiment of the present disclosure not only enhances anti-short circuit ability but also meets the requirements for limit breaking ability.

It is to be understood that the various embodiments/implementations provided in the present disclosure can be combined without causing contradictions, and examples will not be listed here.

In the disclosed embodiments, the terms “first” “second” and “third” are used for descriptive purposes only and should not be construed as indicating or implying relative importance. The terms “a pair” “a” are used to introduce technical features and should not be construed as limiting the specific quantity of the technical feature unless explicitly stated. The term “plurality” refers to two or more unless explicitly stated. Terms such as “installed” “connected” “fixed” etc., should be understood broadly. For example, “connected” may refer to fixed connections, detachable connections, or integral connections. “Connected” may refer to direct connections or indirect connections through an intermediate medium. For those skilled in the art, the specific meanings of the above terms in the disclosed embodiments can be understood based on specific circumstances.

In the description of the disclosed embodiments, it should be understood that the orientation or positional relationships indicated by terms such as “upper” “lower” “left” “right” “front” and “rear” are based on the orientation or positional relationships shown in the drawings. These terms are used only to facilitate the description of the disclosed embodiments and simplify the description, and do not indicate or imply that the device or unit must have a specific orientation or be constructed and operated in a specific orientation. Therefore, these terms should not be construed as limiting the disclosed embodiments.

In the description of this specification, the descriptions of terms such as “one embodiment” “some embodiments” and “specific embodiments” mean that the specific features, structures, materials, or characteristics described in connection with the embodiment or example are included in at least one embodiment or example of the disclosed embodiments. In this specification, the schematic descriptions of the above terms do not necessarily refer to the same embodiment or example. Moreover, the specific features, structures, materials, or characteristics described may be combined in any suitable manner in one or more embodiments or examples.

The above are only preferred embodiments of the disclosed embodiments and are not intended to limit the disclosed embodiments. For those skilled in the art, the disclosed embodiments may have various modifications and changes. Any modifications, equivalent replacements, or improvements made within the spirit and principles of the disclosed embodiments shall be included within the scope of protection of the disclosed embodiments.

1. A relay, comprising:
a contact container having a contact chamber;
a pair of static lead-out terminals fixedly disposed relative to the contact container;
a first magnetizer disposed in the contact chamber and fixed relative to the contact container; and
a push rod assembly comprising a movable contact piece, a second magnetizer, and a third magnetizer disposed in the contact chamber; the movable contact piece is configured to contact with or separate from the pair of static lead-out terminals; the second magnetizer and the third magnetizer are both fixedly connected to the movable contact piece, and along the movement direction of the push rod assembly, the second magnetizer and the third magnetizer are disposed at two opposite sides of the movable contact piece; the first magnetizer and the second magnetizer are located at a side of the movable contact piece facing the static lead-out terminals, and the second magnetizer is disposed between the first magnetizer and the movable contact piece; the second magnetizer and the third magnetizer are configured to form a first magnetic circuit, and the first magnetizer and the third magnetizer are configured to form a second magnetic circuit.

2. The relay according to claim 1, wherein a thickness of the first magnetizer is greater than or equal to a thickness of the second magnetizer.

3. The relay according to claim 1, wherein the contact container further has a pair of first through-holes and a second through-hole both communicating with the contact chamber; the pair of static lead-out terminals are inserted through the pair of first through-holes in one-to-one correspondence;
the relay further comprises a connector inserted through the second through-hole, and comprising a first end and a second end, the first end is connected to the contact container, and the second end is connected to the first magnetizer.

4. The relay according to claim 3, wherein the contact container comprises:
a yoke plate having a third through-hole, the push rod assembly is movably inserted through the third through-hole; and
an insulating cover comprising a top wall and a side wall, one end of the side wall is connected around a periphery of the top wall, and another end of the side wall is connected to the yoke plate;
wherein the first through-holes and the second through-hole are formed in the top wall, and the first end of the connector is connected to an outer surface of the top wall.

5. The relay according to claim 4, wherein the insulating cover comprises a ceramic cover and a frame member, the ceramic cover comprises the top wall and the side wall, the other end of the side wall is connected to the yoke plate through the frame member;
on an outer surface of the top wall, a first metallization layer is provided around a periphery of the first through-hole, and a second metallization layer is provided around the periphery of the second through-hole;
the static lead-out terminals are welded to the top wall through the first metallization layer, and the first end of the connector is welded to the top wall through the second metallization layer.

6. The relay according to claim 4, wherein the top wall and the side wall are of an integrated structure; or, the top wall and the side wall are of a separate structure.

7. The relay according to claim 4, wherein the first magnetizer is spaced apart from an inner surface of the top wall.

8. The relay according to claim 3, wherein the second end of the connector is riveted, welded, or adhesively bonded to the first magnetizer.

9. The relay according to claim 3, wherein the first magnetizer comprises a plurality of stacked magnetic pieces, and the plurality of magnetic pieces are connected to the second end of the connector.

10. The relay according to claim 1, wherein the contact container comprises:
a yoke plate having a third through-hole, the push rod assembly is movably inserted through the third through-hole; and
an insulating cover connected to the yoke plate;
the relay further comprises a fixed frame disposed in the contact chamber and fixedly connected to the yoke plate, and the first magnetizer is fixedly connected to the fixed frame.

11. The relay according to claim 1, wherein the push rod assembly further comprises:
a base;
an elastic member, one end of the elastic member abuts against the base, and another end abuts against a movable member comprising the movable contact piece, the second magnetizer, and the third magnetizer, the elastic member provides an elastic force so that the movable contact piece has a tendency to move toward the static lead-out terminals
a limiting structure disposed on the base and the movable member, for limiting a movement range of the movable member relative to the base; the limiting structure comprises a limiting hole and a limiting member that cooperate with each other, the limiting hole has a first hole wall and a second hole wall opposite to each other along the movement direction of the movable contact piece, and the limiting member is movably inserted between the first hole wall and the second hole wall of the limiting hole;
wherein, when the movable contact piece is separated from the static lead-out terminals, the limiting member is located at the first hole wall of the limiting hole.

12. The relay according to claim 11, wherein a size of the second hole wall is larger than a size of the first hole wall.

13. The relay according to claim 11, wherein the limiting member has a first curved surface used to achieve limiting with the limiting hole when the limiting member is located at the first hole wall of the limiting hole.

14. The relay according to claim 11, wherein the limiting member is a rivet, and the rivet is riveted to the third magnetizer.

15. The relay according to claim 11, wherein the movable member further comprises a fixing member fixedly connected to the third magnetizer, one of the fixing member and the base is provided with the limiting member, and another of the fixing member and the base is provided with the limiting hole.

16. The relay according to claim 2, wherein the push rod assembly further comprises:
a base;
an elastic member, one end of the elastic member abuts against the base, and another end abuts against a movable member comprising the movable contact piece, the second magnetizer, and the third magnetizer, the elastic member provides an elastic force so that the movable contact piece has a tendency to move toward the static lead-out terminals;
a limiting structure disposed on the base and the movable member, for limiting a movement range of the movable member relative to the base; the limiting structure comprises a limiting hole and a limiting member that cooperate with each other, the limiting hole has a first hole wall and a second hole wall opposite to each other along the movement direction of the movable contact piece, and the limiting member is movably inserted between the first hole wall and the second hole wall of the limiting hole;
wherein, when the movable contact piece is separated from the static lead-out terminals, the limiting member is located at the first hole wall of the limiting hole.

17. The relay according to claim 3, wherein the push rod assembly further comprises:
a base;
an elastic member, one end of the elastic member abuts against the base, and another end abuts against a movable member comprising the movable contact piece, the second magnetizer, and the third magnetizer, the elastic member provides an elastic force so that the movable contact piece has a tendency to move toward the static lead-out terminals;
a limiting structure disposed on the base and the movable member, for limiting a movement range of the movable member relative to the base; the limiting structure comprises a limiting hole and a limiting member that cooperate with each other, the limiting hole has a first hole wall and a second hole wall opposite to each other along the movement direction of the movable contact piece, and the limiting member is movably inserted between the first hole wall and the second hole wall of the limiting hole;
wherein, when the movable contact piece is separated from the static lead-out terminals, the limiting member is located at the first hole wall of the limiting hole.

18. The relay according to claim 10, wherein the push rod assembly further comprises:
a base;
an elastic member, one end of the elastic member abuts against the base, and another end abuts against a movable member comprising the movable contact piece, the second magnetizer, and the third magnetizer, the elastic member provides an elastic force so that the movable contact piece has a tendency to move toward the static lead-out terminals;
a limiting structure disposed on the base and the movable member, for limiting a movement range of the movable member relative to the base; the limiting structure comprises a limiting hole and a limiting member that cooperate with each other, the limiting hole has a first hole wall and a second hole wall opposite to each other along the movement direction of the movable contact piece, and the limiting member is movably inserted between the first hole wall and the second hole wall of the limiting hole;
wherein, when the movable contact piece is separated from the static lead-out terminals, the limiting member is located at the first hole wall of the limiting hole.
